(19) United States
(12) Patent Application Publication
(10) Pub. No.: US 2008/0186414 A1
(43) Pub. Date: Aug. 7, 2008

(54) HAND-HELD DEVICE HAVING INTEGRAED PROJETOR

(76) Inventor: Shaoher X. Pan, (US)

Correspondence Address: XIN WEN, 3449 RAMBOW DRIVE, PALO ALTO, CA, 94306, US

(21) Appl. No.: 11/671,946

(22) Filed: Feb. 6, 2007

(51) Int. Cl. H04N 9/31

(52) U.S. Cl. 348/744; 348/E09.025

(57) ABSTRACT

A hand-held electronic device includes a flat-panel display device, a projector integrated in the hand-held electronic device, a data storage device configured to store data; and a display driver coupled to the flat-panel display device and the projector. The display driver can display the image data on the flat panel display device and to project a display image on a surface using the projector in accordance with the data stored in the data storage device.

### BACKGROUND

The present disclosure relates to handheld electronic devices.

Hand-held electronic devices such as personal digital assistants (PDAs) such as Blackberry™, cellular phones, personal music players such as MPEG players, iPOD and Zune™, portable game devices such as Nintendo™DS, digital cameras, video cameras, and portable image/video display devices have become increasingly popular. One drawback for the current hand-held electronic devices is that the displays on the hand-held electronic devices are small for displaying suitable amount of information that a user may be interested. The displays are even less adequate for displaying video or animated pictures as in gaming and portable video devices. Additionally, the small dimensions of the displays on the hand-held electronic devices also make it difficult for a user of a hand-held electronic device to share an image on the display with other people.

### SUMMARY OF THE INVENTION

In a general aspect, the present invention relates to a hand-held electronic device including a flat-panel display device; a projector integrated in the hand-held electronic device; a data storage device configured to store data; and a display driver coupled to the flat-panel display device and the projector, wherein the display driver can display the image data on the flat panel display device and to project a display image on a surface using the projector in accordance with the data stored in the data storage device.

In another general aspect, the present invention relates to a hand-held electronic device including a data storage device configured to store data; a display driver; and a projector rotatably coupled to a body of the hand-held electronic device. The projector can tilt to a first position to project a first display image on a first surface away from the hand-held electronic device in accordance with the data stored in the data storage device under the control of the display driver. The projector can tilt to a second position to project a second display image on a second surface that supports the hand-held electronic device in accordance with the data stored in the data storage device under the control of the display driver.

Implementations of the system may include one or more of the following. The projector can include a spatial light modulator (SLM) that includes a two-dimensional array of pixel cells each configured to produce an image pixel in the display image. The SLM can be selected from the group consisting of a digital mirror device (DMD), a transmissive liquid crystal display (LCD), a liquid-crystal-on-semiconductor (LCOS) device, a low temperature polysilicon (LTPS) device, and a low temperature polysilicon (HTPS) device. The projector can include a light source configured to emit an incident light, wherein the SLM is configured to receive the incident light and produce a spatially modulated light under the control of the display driver in accordance with the data stored in the data storage device. The projector can include a projection system that can project the spatially modulated light to form the image on the surface in accordance with the data stored in the data storage device. At least one of the pixel cells in the SLM is configured to reflect the light emitted from the light source to form the image pixel in the display image. At least one of the pixel cells in the SLM comprises a mirror plate supported by a substrate, wherein the mirror plate can tilt to an “on” position to reflect the incident light to form an image pixel in the display image and to tilt to an “off” position to reflect the incident light away from the display image. At least one of the pixel cells in the SLM can transmit the light emitted from the light source to form the image pixel in the display image. The SLM can include a transmissive liquid crystal device. The projector can be rotatably coupled to a body of the hand-held electronic device. The projector can tilt to a first position to project a first image on a first surface away from the hand-held electronic device, and the projector can tilt to a second position to project a second image on a second surface that supports the hand-held electronic device. The hand-held electronic device can further include two opposing members on the body of the hand-held electronic device, wherein the projector is rotatably coupled to the two opposing members. The hand-held electronic device can further include an antenna that can receive wireless signals and a wireless receiver configured to extract input data from the wireless signals, wherein the input data is subsequently stored in the data storage device.

Embodiments may include one or more of the following advantages. The disclosed hand-held electronic device can provide larger display images compared to conventional hand-held electronic devices. The display image produced by the disclosed hand-held electronic device can contain more information and can be more easily shared among people than conventional hand-held electronic devices.

Another potential advantage of the disclosed hand-held electronic device is that it allows an image to be projected by a projector integrated on the hand-held electronic device on a same surface that supports the hand-held electronic device. For example, images can be projected by the hand-held electronic device on the surface of a desk top, which can serve the purpose similar to a computer monitor or a TV monitor.

Another potential advantage of the disclosed hand-held electronic device is that it provides a compact electronic circuit that can enable an on-device display and a projected display. The hand-held electronic device can be made compact and of small footprint. A user can have the flexibility for viewing a display image on the hand-held device or a display image projected on an image area.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and from a part of the specification, illustrate embodiments of the present invention and, together with the description, serve to explain the principles of the invention.

FIG. 1 illustrates an exemplary hand-held electronic device in accordance with the present specification.

FIG. 2 illustrates the hand-held electronic device of FIG. 1 with the integrated projector projecting an image on a surface away from the hand-held electronic device.

FIG. 3 illustrates the hand-held electronic device of FIG. 1 with the integrated projector projecting an image on an object that supports the hand-held electronic device.

FIG. 4 is a schematic block diagram for the hand-held electronic device.

FIG. 5 illustrates another exemplary hand-held electronic device in accordance with the present specification.

### DETAILED DESCRIPTION

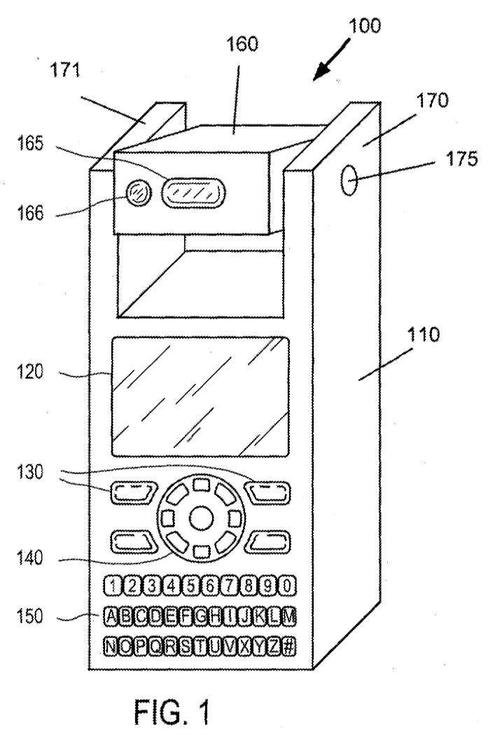

Referring to FIG. 1, a hand-held electronic device 100 includes a body 110, a flat-panel display device 120 on the body 110, one or more columns of key pads 130, a dial-wheel control pad 140, and a keyboard 150 that can include keys for alphabets and numbers. The hand-held electronic device 100 can include a PDA such as a Blackberry™, a cellular phone, a personal music player such as MPEG player, iPOD and Zune™, a portable game device such as Nintendo™ DS, a digital camera, a video camera, a portable image/video display device, and other portable computing devices. The flat-panel display device 120 can be for viewing by a single user or a small number of users. For example, if the hand-held electronic device 100 is a PDA, the flat-panel display device 120 can be used for displaying private information such as emails, caller or recipient's phone number during a phone call. The flat-panel display device 120 can also display a clock time, alert or reminder messages, an address book, a speed dial list, a map, a calendar, a schedule, and other information. The body 110 can include two walls 170 and 171 that can be extended from two opposing sides of the body 110. The hand-held electronic device 100 can also include a projector 160 that is mechanically and electronically integrated in the hand-held electronic device 100. The projector 160 can be rotatably connected to the two walls 170 and 171. For example, the projector 160 can include a shaft that is mounted to holes 175 on the two walls 170 and 171. The projector 160 can include a window 165 and a sensor 166. When not used, the projector 160 can be positioned in a downward position such that the window 165 and the sensor 166 are projected inside. A lid can also be provided to cover the window 165 when the projector 160 is not in use.

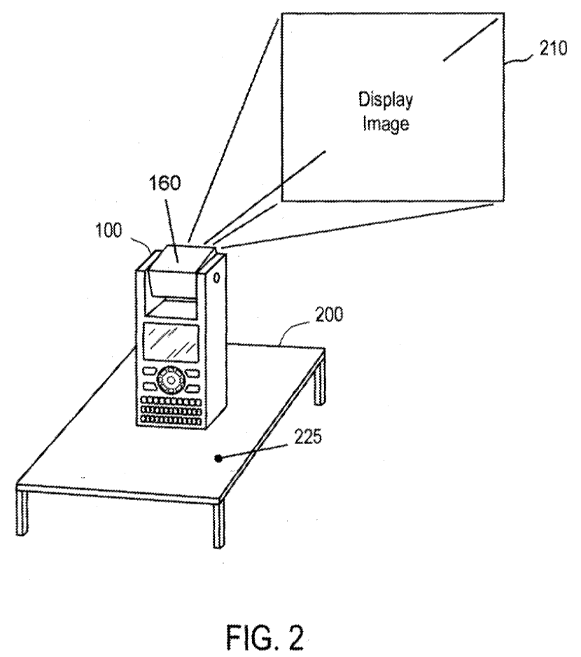

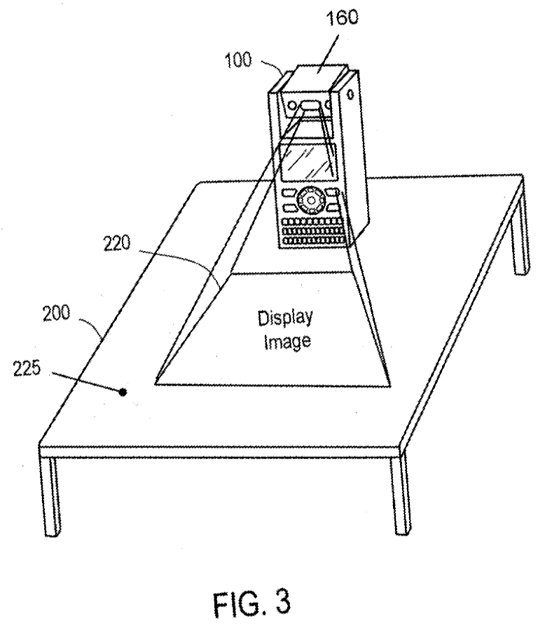

Referring to FIGS. 2 and 3, the hand-held electronic device 100 can placed on the top of a table 200. The projector 160 can rotate around an axis defined by the shaft to different tilt orientations: upward or downward, to the front or the back of the hand-held electronic device 100. For example, the projector 160 can project a display image 210 on a surface away from the table 200. The display image 210 can be projected on the surface of a wall or a screen. The projector 160 can also tilt downward to project a display image 220 on a surface 225 on the top of the table 200. A user of the hand-held electronic device 100 can sit by the table and view the display image 220 similar to a user watches a computer monitor or a TV monitor. The hand-held electronic device 100 can thus be used as a desktop or laptop computer for information access and processing, as well as and for information display. The display images 210 and 220 can include text, a static image, a video or animated image, and other image information that computer monitor or a TV may display.

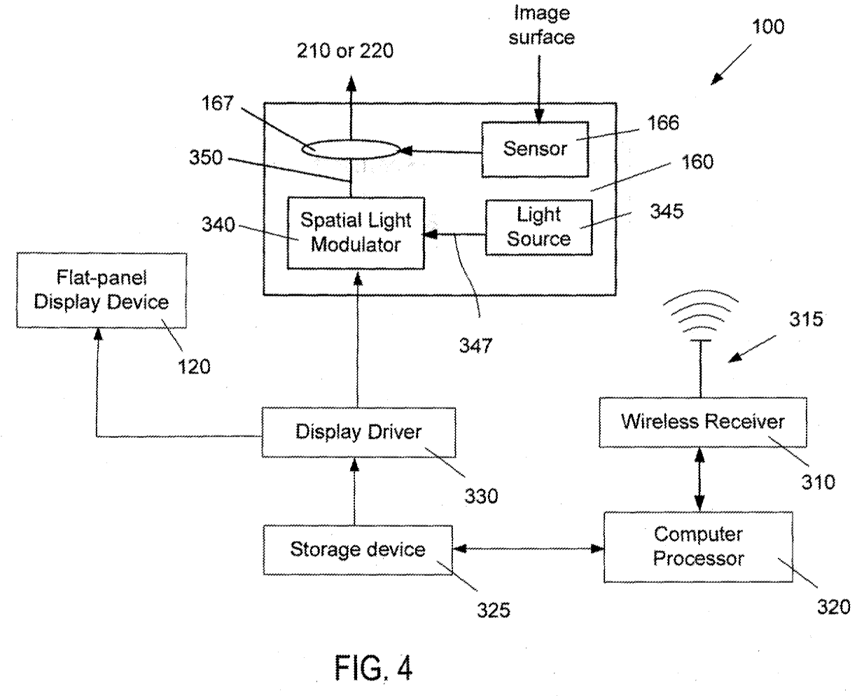

Referring to FIG. 4, the hand-held electronic device 100 can include a wireless receiver 310, an antenna 315 coupled to the wireless receiver 310, a computer processor 320, and a storage device 325 that can store data to be displayed by the flat-panel display device 120 and the projector 160. Wireless signals can be received by the antenna 315 and decoded by the wireless receiver 310. The wireless signals can be based on WIFI, WI-Max, cellular, or other wireless standards. The data decoded from the wireless signals can be stored in the store device 325. The store device 325 can include flash memory, EPROM, RAM, and a magnetic micro drive. A display driver 330 can receive the data from the storage device 325 and control the flat-panel display device 120 and the projector 160 to display images in accordance with the data stored in the storage device 325. One advantageous feature of the hand-held electronic device 100 is that a same display driver can provide control signals for the projector 160 and the flat-panel display device 120. The shared display driver can significantly decrease the size of the electric circuit board and allow the hand-held electronic device to be compact or of small foot print.

The projector 160 can include a spatial light modulator (SLM) 340 that can modulate the incident light 347 emitted by a light source 345 to form a spatially modulated light 350. Examples of the light source 345 can include a light emitting diode (LED), a solid-state laser, or a low-power high-rightness discharge lamp. The spatially modulated light 350 can be projected by a projection system 167 and through the window 165 to form the display image 210 or 220 on an image surface. The image surface can be a table top, a wall, or a screen. The sensor 166 in the projector 160 can detect the distance of the image surface from the projector 160 using an infrared (IR) beam. The sensor 166 can output a signal to the project system 167 in response to the measurement to control the projection system 167 to focus the display image 210 or 220.

The SLM 340 can include both reflective and transmissive light modulation devices. The SLM 340 can include a digital mirror device (DMD) including an array of micro mirrors. Each micro mirror can include a mirror plate that can be tilted about a hinge that is supported by a hinge support post connected to a substrate. The tilting of the tiltable mirror plate can be controlled by the display driver 330 in response to the data stored in the storage device 325. The mirror plates can be tilted to “on” positions to reflect incident light 347 emitted from the light source 345 to produce the spatially modulated light 350, which can be subsequently projected for form the display image 210 or 220. The mirror plates can also be tilted to “off” positions to reflect incident light 347 away from the display image 210 or 220. Mechanical stops may be provided on the substrate for stopping the tilt movement of the mirror plates and define the orientations of the mirror plates at the “on” and the “off” positions. Details about the structures and operations of micro mirrors are disclosed for example in commonly assigned U.S. Pat. No. 7,167,298, titled “High contrast spatial light modulator and method”, the content of which are incorporated herein by reference.

The SLM 340 can also include a transmissive LCD that includes a two-dimensional array of liquid crystal pixel cells that each can include a pair of polarizers and, a pair of electrodes and, and liquid crystal material in between the electrodes. The polarization axes of the pair of polarizers and are typically crossed. The electric voltage across the electrodes can be controlled by the display driver 330. The voltage values at the pixel cell can determine the orientation of the liquid crystal material between the electrodes, which can modify the amount of the light that can transmit through the pixel cell in the transmissive LCD to produce light. In an “off” state, almost all the light is blocked by the pixel cell. In an “on” state, a maximum fraction of light can transmit through the pixel cell.

Other examples of the SLM 340 can include a liquid-crystal-on-semiconductor (LCOS) device, a low temperature polysilicon (LTPS) device, and a low temperature polysilicon (HTPS) device

The disclosed hand-held electronic device can include one or more of the following advantages. The disclosed hand-held electronic device can provide larger display images compared to conventional hand-held electronic devices. The display image produced by the disclosed hand-held electronic device can contain more information and can be more easily shared among people than conventional hand-held electronic devices. The disclosed hand-held electronic device can thus overcome an important drawback in the convention system. The disclosed hand-held electronic device also allows an image to be projected by a projector integrated on the hand-held electronic device on a same surface that supports the hand-held electronic device. For example, images can be projected by the hand-held electronic device on the surface of a desk top, which can serve the purpose similar to a computer monitor on a TV monitor. The disclosed hand-held electronic device can include a compact electronic circuit that can enable an on-device display and a projected display. The hand-held electronic device can be made compact and of small footprint. A user can have the flexibility for viewing a display image on the hand-held device or a display image projected on an image area.

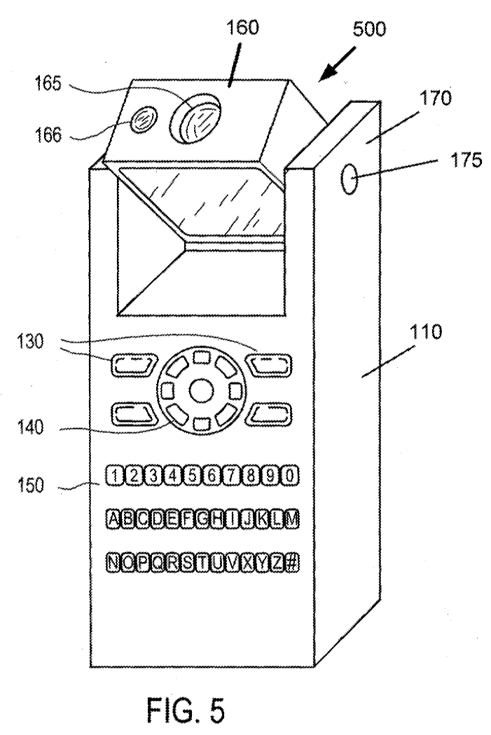

It is understood that the disclosed systems and methods are not limited to the examples described above. For example, a hand-held electronic device 500, as shown in FIG. 5, in accordance with the present specification may not include a flat-panel display. All the information needed for operating the hand-held electronic device 500 can be displayed by the projector 160. The projector can include other types of configurations that can project images in response to digital data. The user interface and the form factor of the hand-held electronic device can also differ in accordance with the specific applications such as music player, a digital camera, or a video camera. The projector and flat panel can display color images or monochrome images. Furthermore, a holder can hold the hand-held electronic device during the projection of a display image. The holder can provide additional stability to the hand-held electronic device and thus may produce more stable display image.

What is claimed is:

1. A hand-held electronic device, comprising:
a flat-panel display device;
a projector integrated in the hand-held electronic device;
a data storage device configured to store data; and
a display driver coupled to the flat-panel display device and the projector, wherein the display driver is configured to display the image data on the flat panel display device and to project a display image on a surface using the projector in accordance with the data stored in the data storage device.

2. The hand-held electronic device of claim 1, wherein the projector comprises a spatial light modulator (SLM) that includes a two-dimensional array of pixel cells each configured to produce an image pixel in the display image.

3. The hand-held electronic device of claim 2, wherein the SLM is selected from the group consisting of a digital mirror device (DMD), a transmissive liquid crystal display (LCD), a liquid-crystal-on-semiconductor (LCOS) device, a low temperature polysilicon (LTPS) device, and a low temperature polysilicon (HTPS) device.

4. The hand-held electronic device of claim 2, wherein the projector comprises a light source configured to emit an incident light, wherein the SLM is configured to receive the incident light and produce a spatially modulated light under the control of the display driver in accordance with the data stored in the data storage device.

5. The hand-held electronic device of claim 2, wherein the projector comprises a projection system configured to project the spatially modulated light to form the image on the surface in accordance with the data stored in the data storage device.

6. The hand-held electronic device of claim 2, wherein at least one of the pixel cells in the SLM is configured to reflect the light emitted from the light source to form the image pixel in the display image.

7. The hand-held electronic device of claim 6, wherein the at least one of the pixel cells in the SLM comprises a mirror plate supported by a substrate, wherein the mirror plate is configured to tilt to an “on” position to reflect the incident light to form an image pixel in the display image and to tilt to an “off” position to reflect the incident light away from the display image.

8. The hand-held electronic device of claim 1, wherein at least one of the pixel cells in the SLM is configured to transmit the light emitted from the light source to form the image pixel in the display image.

9. The hand-held electronic device of claim 8, wherein the SLM comprises a transmissive liquid crystal device.

10. The hand-held electronic device of claim 1, wherein the projector is rotatably coupled to a body of the hand-held electronic device.

11. The hand-held electronic device of claim 10, wherein the projector is configured to tilt to a first position to project a first image on a first surface away from the hand-held electronic device, and the projector is configured to a tilt to a second position to project a second image on a second surface that supports the hand-held electronic device.

12. The hand-held electronic device of claim 10, further comprising two opposing members on the body of the hand-held electronic device, wherein the projector is rotatably coupled to the two opposing members.

13. The hand-held electronic device of claim 1, further comprising an antenna configured to receive wireless signals and a wireless receiver configured to extract input data from the wireless signals, wherein the input data is subsequently stored in the data storage device.

14. A hand-held electronic device, comprising:
a data storage device configured to store data;
a display driver; and
a projector rotatably coupled to a body of the hand-held electronic device, wherein the projector is configured to tilt to a first position to project a first display image on a first surface away from the hand-held electronic device in accordance with the data stored in the data storage device under the control of the display driver, and wherein the projector is configured to tilt to a second position to project a second display image on a second surface that supports the hand-held electronic device in accordance with the data stored in the data storage device under the control of the display driver.

15. The hand-held electronic device of claim 14, further comprising a flat-panel display device, wherein the display driver is configured to control the flat-panel display device to display an image on the flat panel display device and to control the projector to project the first display image or the second display image in accordance with the data stored in the data storage device.

16. The hand-held electronic device of claim 14, wherein the projector comprises a spatial light modulator (SLM) that includes a two-dimensional array of pixel cells each configured to produce an image pixel in the display image.

17. The hand-held electronic device of claim 16, wherein the SLM is selected from the group consisting of a digital mirror device (DMD), a transmissive liquid crystal display (LCD), a liquid-crystal-on-semiconductor (LCOS) device, a low temperature polysilicon (LTPS) device, and a low temperature polysilicon (HTPS) device.

18. The hand-held electronic device of claim 16, wherein the projector comprises a light source configured to emit an incident light, wherein the SLM is configured to receive the incident light and produce a spatially modulated light under the control of the display driver in accordance with the data stored in the data storage device.

19. The hand-held electronic device of claim 16, wherein at least one of the pixel cells in the SLM comprises a mirror plate supported by a substrate, wherein the mirror plate is configured to tilt to an “on” position to reflect the incident light to form an image pixel in the display image and to tilt to an “off” position to reflect the incident light away from the display image.

20. The hand-held electronic device of claim 16, wherein the SLM comprises a transmissive liquid crystal device.

21. The hand-held electronic device of claim 16, further comprising two opposing members on the body of the hand-held electronic device, wherein the projector is rotatably coupled to the two opposing members.

22. The hand-held electronic device of claim 16, further comprising an antenna configured to receive wireless signals and a wireless receiver configured to extract input data from the wireless signals, wherein the input data is subsequently stored in the data storage device.
